(19) United States
(12) Patent Application Publication
(10) Pub. No.: US 2014/0284988 A1
(43) Pub. Date: Sep. 25, 2014

(54) SEATING AIDS FOR PARALYZED INDIVIDUALS

(71) Applicant: RAMOT AT TEL-AVIV UNIVERSITY LTD., Tel Aviv (IL)

(72) Inventor: Amit Gefen, Ganei Tikva (IL)

(21) Appl. No.: 14/354,868

(22) PCT Filed: Oct. 16, 2012
(86) PCT No.: PCT/IL2012/050406

§ 371 Date: Apr. 28, 2014

Related U.S. Application Data
(60) Provisional application No. 61/551,646, filed on Oct. 26, 2011.

(51) Int. Cl. A61G 7/057; A61G 5/10

(52) U.S. Cl. CPC A61G 7/05769; A61G 5/1043; A61G 2005/1045; A61G 2005/1091
USPC 297/452.41; 5/652

(57) ABSTRACT

The invention provides a seat cushion for an individual suffering from loss of sensation in the buttocks but having sensation in higher regions of the trunk. The cushion may be used, for example, in individuals who have undergone spinal cord injury (SCI). The seat cushion is formed from a flexible material and includes two closed systems containing a fluid. Each closed system includes a one or more buttock cells and one or more lateral cells, each buttock cell of the system being in fluid communication with at least one of the lateral cells of the system. The buttock cells determine a cushion layer and at least a portion of the lateral cells is above the cushion layer.

### FIELD OF THE INVENTION

This invention relates to medical devices, and more specifically to such devices for aiding paralyzed individuals.

### BACKGROUND OF THE INVENTION

Sustained mechanical loads applied to a body surface, as occurs during prolonged sitting or lying in one position, tends to cause damage in the weight-bearing soft tissues due to the cellular distortion and secondary ischemic effects, as blood vessels are obstructed. The onset of these damage pathways is normally accompanied by a sense of pain, which induces the individual to shift his body weight away from the currently weight-bearing body surface to another body surface. Loss of this protective mechanism for avoiding prolonged tissue loading and the resulting cellular deformations and ischemic insult is known to occur in the buttocks of wheelchair users, for example, in cases of individuals with spinal cord injury (SCI) due to blockade of the sensory pathway from the buttock tissues to the brain. This sensory loss in SCI is the primary factor responsible for the high incidence of pressure ulcers and gradual morphological changes to the hard and soft tissues at the weight-bearing regions. In the case of prolonged sitting without regular shifting of the body-weight, shape adaptation occurs in the ischial tuberosities which become more flattened due to the prolonged sitting, and disuse atrophy occurs in the gluteus muscles of the buttocks which thin substantially and become replaced by intramuscular and enveloping fat.

One method for minimizing the occurrence of pressure ulcers in prolonged sitting involves training of at-risk individuals to change their posture frequently, and thus relieve tissue loads under the bony prominences of the buttocks, much like healthy individuals do. Typical recommendations are to relieve the pressure under the buttocks every 30 minutes during sitting, and to lie down for 15 minutes following every 2 hours of sitting. The Agency for Health Care Policy and Research (AHCPR) of the US Department of Health recommends relieving sitting pressures at least every 1 hour, and individuals who are body-abled are advised to shift their body-weight every 15 minutes. These guidelines, however, suffer from low patient compliance, as well as from lack of clinical evidence for their effectiveness.

Another method involves redistributing body pressures over a larger area, particularly near the bony prominences. This method utilizes cushions designed to reduce the surface pressure on the skin of the buttocks by increasing the contact area between the buttocks and sitting surface. Such cushions may be filled with a viscous gel or compliant foam which adapts to the shape of the buttocks of the individual, or may be custom-made contoured cushions which match the form of the buttocks of the individual. Typically the materials are selected so that they can also regulate dissipation of heat and moisture.

However, even when sitting on such a pressure-redistributing cushion, the soft tissues of the buttocks, particularly subdermal tissues, are still exposed to substantial deformations, which can eventually cause cell death and tissue breakdown. Active cushions attempt to resolve this (problem by cyclically inflating cells or pockets within the cushion to intermittently shift the body-weight from one body surface region to another. These cushions require an electromechanical system which is connected to a power source (e.g. a battery), and they change the posture without any input from the patient, which can be annoying, and even dangerous. The predetermined pattern of inflating and deflating the cells/pockets does not necessarily relieve loads at the specific anatomical sites that require it at a given time, and setting a cyclic pattern that meets the possibly changing needs of an individual patient, using an evidence-based approach, is extremely difficult to achieve.

US Patent Publication 2011041250 discloses a wheelchair cushion having a pair of side air cells extending upwardly from the upper surface side of the base member at both end sides in the lateral direction of the base member. The side air cells have a larger front-rear direction size than in the lateral direction thereof. Each side air cell is configured to inflate outward in the lateral direction. The side air cells when inflated expand outward in the lateral direction, so that the outer side surfaces of the side air cells abut against the wheelchair armrests and thus prevent collapse of the side air cells under the patient's weight.

US Patent Publication 20100101026 discloses a cushion having an adaptable surface system having a plurality of individually adjustable surface units and a plurality of pressure sensors. Each pressure sensor corresponds to one of the adjustable subsurface units and is positioned to measure an amount of pressure exerted upon the subsurface unit. The system also includes a controller that receives a first pressure value from a pressure sensor, compares the value to a threshold, and adjusts the height of the first subsurface unit based on the comparison. The controller also receives a second pressure value from a second pressure sensor, compares the second pressure value to the threshold, and adjusts the height of a second subsurface unit based on the comparison.

### SUMMARY OF THE INVENTION

The present invention provides a seat cushion for an individual suffering from loss of sensation in the buttocks but having sensation in higher regions of the trunk. The cushion may be used, for example, in individuals who have undergone spinal cord injury (SCI). The cushion of the invention provides tactile stimulation to regions of the surface of the individual's body where the individual has retained tactile sensitivity (e.g. above the SCI level) to induce the individual to shift his sitting position. The cushion thus provides tactile sensory compensation, by transferring the sense of weight-bearing pressures from an insensitive body site which bears bodyweight loads (e.g. a body site affected by a neural injury to a different, sensitive site which is not necessarily weight-bearing at the time. By repetitively shifting the location of the tactile stimulation, the cushion promotes frequent changes in posture, which tend to reduce the risk of pressure ulcers.

The cushion comprises multiple inter-connected pairs of expandable cells. For example, consider for simplicity two pairs of cells—a left pair comprising a left buttock cell and a left lateral cell, and a right pair comprising a right buttock cell and a right lateral cell. The left buttock cell is in fluid (which could be either liquid or gas) communication with the left lateral cell and the right buttock cell is in fluid communication with the right lateral cell. When most of the individual's weight is applied to the right buttock cell (i.e. the individual is sitting tilted to his right), fluid will gradually flow from the (loaded) right buttock cell to the (initially unloaded) right lateral cell which then causes the right lateral cell to expand. The expanding right lateral cell will eventually press upon a body surface of the individual where the individual has retained tactile sensitivity. Pressing of the expanded right lateral cell upon the body surface induces the individual to shift his sitting position so that the individual is sitting tilted to the left in order to relive the pressure of the expanded right lateral cell. When the individual is sitting tilted to his left, most of the individual's weight is now applied to the left buttock cell. Fluid then flows gradually from the left buttock cell to the left lateral cell which causes the left lateral cell to expand. The expanding left lateral cell then starts pressing upon another body surface of the individual where the individual has retained tactile sensitivity. Pressing of the expanded left lateral cell upon the body surface ultimately induces the individual to shift his sitting position so that the individual returns to sitting tilted to the right in order to relive the pressure of the expanded left lateral cell. The individual is thus induced to periodically shift the weight-bearing surfaces of the buttocks in response to the tactile stimulations—which are transferred from the actual (but insensitive) weight-hearing sites of the buttocks to more proximal, sensitive sites. The present invention thus utilizes a tactile sensory compensation mechanism.

In an embodiment of the invention, the cushion does not require external power to deliver the tactile stimulation to sensitive body surface regions, but rather utilizes the individual's bodyweight and gravity, and/or elastic properties of the expandable cells, and/or spring-based mechanisms to deflate cells by emptying them from fluid, in order to generate the tactile stimulations. Hence, the cushion allows maximum mobility as well as sustainability without the need for batteries or other energy source.

The cushion of the invention may integrate feedback from the patient into the dynamics of postural changes, so that the patient possesses control of his posture (to the extent possible given their individual neuromuscular condition) as well as control of the pattern of postural changes, much like a normal individual. The patient's control over posture and postural changes is advantageous both from a physiological point of view (loads are timely relieved at sites which were previously highly loaded), and from a psychological point of view, as the individual feels that he or she controls the process, rather than being passively moved from one posture to another.

Thus, in one of its aspects, the invention provides a seat cushion formed from a flexible material comprising:
a first closed system containing a fluid, the first closed system comprising one or more first buttock cells and one or more first lateral cells, each first buttock cell being in fluid communication with at least one of the first lateral cells; and
a second closed system containing a fluid comprising one or more second buttock cells and one or more second lateral cells, each second buttock cell being in fluid communication with at least one of the second lateral cells;
wherein the first and second buttock cells determine a cushion layer and at least a portion of the first and second lateral cells is above the cushion layer.

The seat cushion of the invention may further comprise one or more additional closed systems, each closed system containing a fluid, and each additional closed system comprising one or more buttock cells and one or more lateral cells.

In one embodiment of the invention, for each closed system, the buttock cell of the system has a maximum attainable volume when expanded, and the lateral cell of the system has a maximum attainable volume when expanded and the system contains a volume of the fluid that is less than the total of the maximum volume of the buttock cell plus the maximum volume of the lateral cell.

The fluid may be an incompressible fluid.

One or more of the lateral cells may protrude over the cushion layer determined by the first and second buttock cells when the lateral cell is inflated.

One or more of the buttock cells may be in fluid communication with a lateral cell via a conduit. The conduit may be provided with a flow restrictor. One or more of the conduits may be provided with a flow-meter. The cushion may include a processor configured to analyze the flow measurements to determine when a user of the cushion has shifted body-weight between different buttock cells. The cushion may further comprise an alarm and the processor may be configured to activate the alarm when the user has not shifted body-weight between different buttock cells in accordance with a predetermined pattern of body-weight shifting.

The cushion may further comprise a cooling device for cooling the fluid.

The invention also provides a system comprising a chair or a wheelchair and a seat cushion of the invention.

The invention further provides a seat cushion formed from a flexible material comprising:
a first closed system containing a fluid, the first closed system comprising one or more first buttock cells and one or more first lateral cells; and
a second closed system containing a fluid comprising one or more second buttock cells and one or more second lateral cells; and
wherein the first and second buttock cells determine a cushion layer and at least a portion of the first and second lateral cells is above the cushion layer.
wherein applying pressure on a first buttock cell causes fluid found within the first buttock cell upon which pressure was applied to flow into one or more of the first lateral cells, and wherein relief of pressure from a first buttock cell causes fluid found within one or more of the first lateral cells to flow into the first buttock cell from which pressure was relieved; and
wherein applying pressure on a second buttock cell causes fluid found within the second buttock cell upon which pressure was applied to flow into one or more of the second lateral cells, and wherein relief of pressure from a second buttock cell causes fluid found within one or more of the second lateral cells to flow into the second buttock cell from which pressure was relieved.

The invention also provides a method for inducing an individual to shift body weight from a first body surface to a second body surface comprising:

(a) providing a seat cushion of the invention; and

(b) seating the individual on the seat cushion.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 shows a schematic illustration of a cushion in accordance with one embodiment of the invention; and

FIG. 2 shows schematically four stages in the use of the cushion of FIG. 1.

### DETAILED DESCRIPTION OF EMBODIMENTS

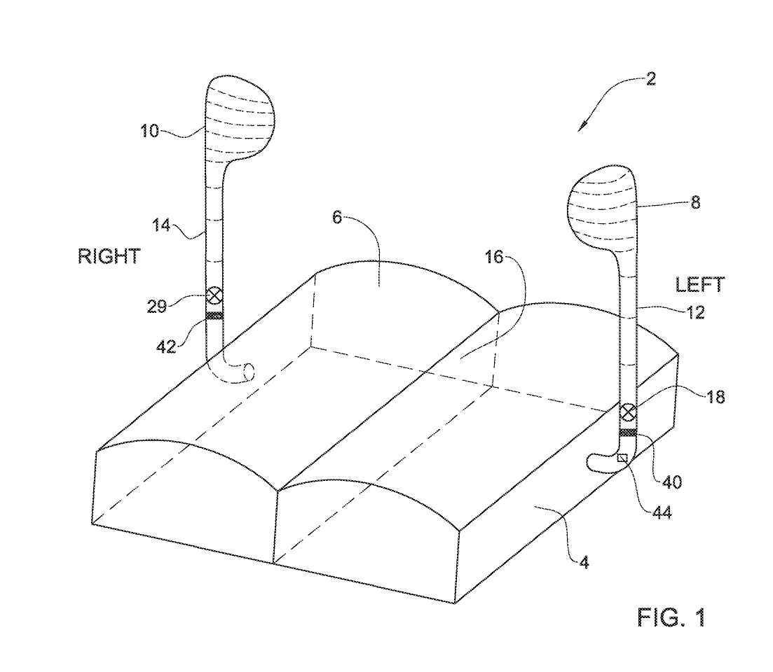

FIG. 1 shows a schematic illustration of a cushion 2 in accordance with one embodiment of the invention. The cushion 2 is dimensioned to be placed on the seat of a chair, such as a wheelchair. The cushion 2 is made from a flexible material and comprises four inflatable cells, as follows: a left buttock cell 4 a right buttock cell 6, a left lateral cell 8, and a right lateral cell 10. The left buttock cell 4 is in fluid communication with the left lateral cell 8 via a left conduit 12, and the right buttock cell 6 is in fluid communication with the right lateral cell 10 via a right conduit 14. The left buttock cell 4, the left conduit 12 and the left lateral cell 8 form a first closed system containing a given volume of a fluid (not shown in FIG. 1). Similarly, the right buttock cell 6, the right conduit 14 and the right lateral cell 10 form a second closed system that also contains a volume of fluid (not shown in FIG. 1). The left and right buttock cells are separated from each other by a common partition 16 so that fluid cannot flow between first and second closed systems.

The left and right buttock cells determine a cushion layer. The left and right lateral cells are above the cushion layer, so that when a user sits on the cushion layer formed by the left and right buttock cells, the left and right lateral cells may be in proximity to higher body parts of the user such as the trunk.

The fluid contained in either closed system may be an incompressible liquid with specific viscous properties selected for controlling the rate by which fluid flows between the buttock cells and the lateral cells. The fluid may also have electrical conduction properties so that it could be used to activate flow-meters at the conduits, for measuring parameters that relate to the postural dynamics of the user. The fluid may also have certain thermal capacity properties selected for absorbing heat or actively cooling the weight-bearing tissues, in order to reduce metabolic rate and thus provide additional protection to the weight-bearing tissues against pressure ulcers.

The flexible material of the cushion 2 is impervious to the fluids contained in the first and second closed systems. Each of the four cells 4, 6, 8, and 10 has a maximum attainable volume when expanded, and can be deflated to a smaller volume e.g. by elastic recoil and/or with the aid of spring-driven systems. The total volume of the fluid in each of the first and second closed systems is selected to be less than the total of the maximum volume of the buttock cell plus the maximum volume of the lateral cell of the system, in order to allow the occurrence of flow from one cell in the system to the other through the connecting conduit of the system. Thus, compression of either one of the buttock cells 4 and 6 causes the fluid to flow out of the buttock cell through the respective conduit 12 and 14, and into the respective lateral cell 8 and 10. Similarly, compression of either one of the lateral cells 8 and 10 causes the fluid to flow out of the lateral cell through the respective conduit 12 and 14 into the respective buttock cell 4 and 6.

When a given pressure is applied to one of the buttock cells, the rate of flow of the fluid from the buttock cell to the corresponding lateral cell will depend, inter alia, on the viscosity (and hence also temperature) of the fluid, and the diameter and length of the conduit 12 or 14. Further control of the flow rate may be achieved by providing the left and right conduits 12 and 14 with a flow restrictor (also known as a flow limiter) such as an adjustable valve 18 and 20, respectively. The flow restrictors may allow adjustment and setting of the rate of flow of the fluid through each of the conduits to meet the needs of an individual user. For example, in a case where an individual user had a history of pressure ulcers in one side of the buttocks, the flow restrictors could be adjusted for that specific individual so that he spends less time on the previously injured side by using a faster flow rate, in order to minimize the risk of reoccurrence of the injury. Additionally, the flow restrictors may allow adjustment and setting of different flow rates in each flow direction. For example, the flow rate of the fluid from buttock cells 4 and 6 to the respective lateral cells 8 and 10 may be set to be slower than the flow rate of the fluid from lateral cells 8 and 10 to the respective buttock cells 4 and 6.

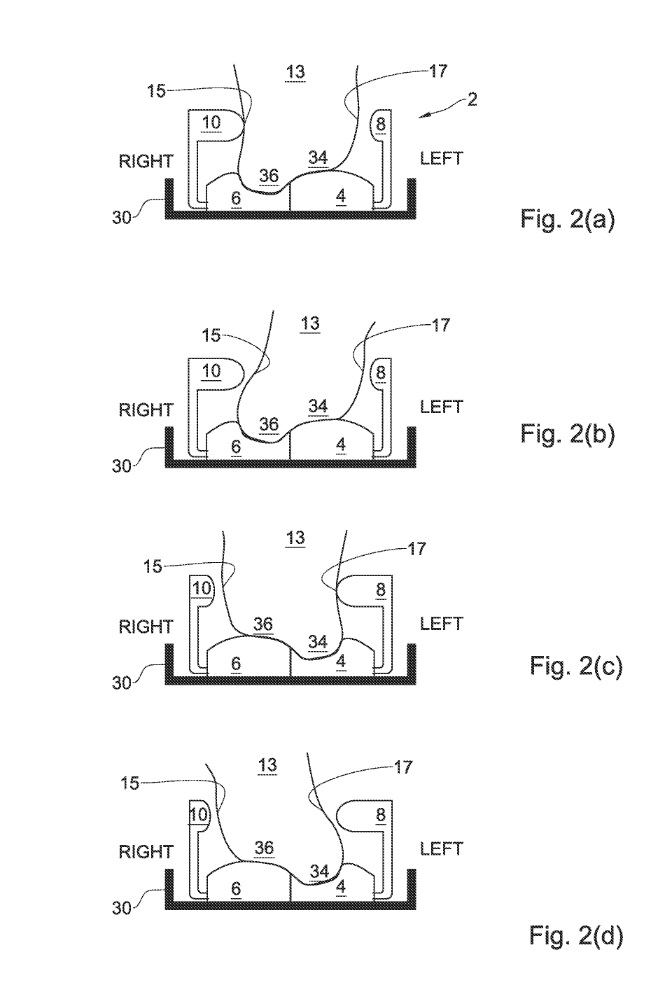

FIG. 2 shows schematically use of the cushion 2. Referring, first of all to FIG. 2a, the cushion 2 has been placed on a chair 30, that may be, for example, a wheelchair. An individual 13 is sitting on the cushion 2 with his right buttock 36 pressing on the right buttock cell 6, and his left buttock 34 pressing on the left buttock cell 4. in FIG. 2a, the individual is sitting on the cushion 2 tilted to his right, so that the individual's body is applying more pressure to the right buttock cell 6 than to the left buttock cell 4. With this position of the individual, the left buttock cell 4 is more expanded than the right buttock cell 6. Corresponding with this, the right lateral cell 10 is more expanded than the left lateral cell 8.

Referring still to FIG. 2a, the expanded right lateral cell 10 protrudes over the right buttock cell 6 and thus presses upon a body surface 15 on the individual's right lateral side where the individual has tactile sensitivity. The sensation of the pressure generated by the right lateral cell 10 on the (sensitive) right lateral side of the trunk induces the individual to tilt to his left, as shown in FIG. 2b. Tilting to the left transfers some of the individual's body-weight from the right buttock cell 6 to the left buttock cell 4. Shifting the body-weight to the left increases the pressure on the left buttock cell 4 which causes the fluid to flow from the left buttock cell 4 to the left lateral cell 8. Simultaneously, the decrease in pressure on the right buttock cell 6 causes fluid to flow under the influence of gravity, and possibly also due to elastic recoil of the lateral cell, and/or possibly with the aid of spring-driven mechanisms in the lateral cell, from the right lateral cell 10 to the right buttock cell 6.

The flow of fluid from the left buttock cell 4 to the left lateral cell 8 and from the right lateral cell 10 to the right buttock cell 6 continues until the cushion 2 has attained the configuration shown in FIG. 2c, in which the right buttock cell 6 is more expanded than the left buttock cell 4 and the left lateral cell 8 is more expanded than the right lateral cell 10. The expanded left lateral cell 8 protrudes over the left buttock cell 4 and thus presses upon a body surface 17 on the individual's left lateral side where the individual has tactile sensitivity. As previously explained, sensation of the pressure generated by the left lateral cell 8 on the (sensitive) left lateral side of the trunk induces the individual to now tilt back to his right, as shown in FIG. 2d. Tilting back to the right transfers some of the individual's body-weight from the left buttock cell 4 to the right buttock cell 6. Shifting the body-weight to the right increases the pressure on the right buttock cell 6 which causes the fluid to flow from the right buttock cell 6 to the right lateral cell 10. Simultaneously, the decrease in pressure on the left buttock cell 4 causes fluid to flow, under the influence of gravity, and possibly also due to elastic recoil of the lateral cell, and/or possibly with the aid of spring-driven mechanisms in the lateral cell, from the left lateral cell 8 to the left buttock cell 4. The flow of fluid from the right buttock cell 6 to the right lateral cell 10 and from the left lateral cell 8 to the left buttock cell 4 continues until the cushion 2 has regained the configuration shown in FIG. 2a, The cycle can then begin again.

The cushion 2 shown in FIGS. 1 and 2 included two closed systems where each closed system consisted of two confluent cells (a single buttock cell and a single lateral cell). This is by way of example only, and the cushion of the invention may include any number of closed systems, and each closed system may include any number of confluent cells. Thus, for example, the cushion may contain three or more buttock cells, where each buttock cell is in fluid communication with any number of lateral cells. The cushion may include, for example, a closed system comprising a front buttock cell in fluid communication with a front lateral cell and a second closed system comprising a rear buttock cell and a rear lateral cell in order to provoke anterior-posterior motions of the trunk of the seated user instead of, or in addition to lateral (left/right) movements.

Referring again to FIG. 1, the cushion 2 may be provided with a flow monitoring system comprising flow-meters 40 and 42 which monitor the flow of the fluid in the left and right conduits 12 and 14, respectively. The flow measurements may be input to a processor 44 which analyzes the flow measurements to determine whether the individual has periodically shifted his sitting position as required or as anticipated, or for giving the individual feedback on his postural changes while using the cushion, or for holding a record of postural changes. An alarm may also be provided (not shown) that is activated when the processor determines that the individual has not been shifting his sitting position as required. A cooling system for the fluids may also be installed in the buttock cells (not shown) in order to cool down weight-bearing tissues in a controllable manner, for slowing down metabolism which could be beneficial in further minimizing the risk for pressure ulcers.

1. A seat cushion formed from a flexible material comprising:
a first closed system containing a fluid, the first closed system comprising one or more first buttock cells and one or more first lateral cells, each first buttock cell being in fluid communication with at least one of the first lateral cells; and
a second closed system containing a fluid comprising one or more second buttock cells and one or more second lateral cells, each second buttock cell being in fluid communication with at least one of the second lateral cells;
wherein the first and second buttock cells determine a cushion layer and at least a portion of the first and second lateral cells is above the cushion layer.

2. The seat cushion according to claim 1, further comprising one or more additional closed systems, each closed system containing a fluid, and each additional closed system comprising one or more buttock cells and one or more lateral cells.

3. The seat cushion according to claim 1 wherein, for each closed system, the buttock cell of the system has a maximum attainable volume when expanded, and the lateral cell of the system has a maximum attainable volume when expanded and the system contains a volume of the fluid that is less than the total of the maximum volume of the buttock cell plus the maximum volume of the lateral cell.

4. The seat cushion according to claim 1, wherein the fluid is an incompressible fluid.

5. The seat cushion according to claim 1, wherein one or more of the lateral cells protrudes over the cushion layer determined by the first and second buttock cells when the lateral cell is inflated.

6. The seat cushion according to claim 1, wherein one or more of the buttock cells is in fluid communication with a lateral cell via a conduit.

7. The seat cushion according to claim 1, wherein the flexible material of one or both of the lateral cells is an elastic material.

8. The seat cushion according to claim 1, further comprising one or more spring-driven mechanisms to drive fluid from a lateral cell to a buttock cell.

9. The seat cushion according to claim 6, wherein the conduit is provided with a flow restrictor.

10. The seat cushion according to claim 9, wherein one or more of the conduits is provided with a flow-meter.

11. The seat cushion according to claim 10, further comprising a processor configured to analyze the flow measurements to determine when a user of the cushion has shifted body-weight between different buttock cells.

12. The seat cushion according to claim 11, further comprising an alarm and the processor is configured to activate the alarm when the user has not shifted body-weight between different buttock cells in accordance with a predetermined pattern of body-weight shifting.

13. The seat cushion according to claim 1, further comprising a cooling device for cooling the fluid.

14. A system comprising a chair or a wheelchair and a seat cushion according to claim 1.

15. A seat cushion formed from a flexible material comprising:
a first closed system containing a fluid, the first closed system comprising one or more first buttock cells and one or more first lateral cells; and
a second closed system containing a fluid comprising one or more second buttock cells and one or more second lateral cells; and
wherein the first and second buttock cells determine a cushion layer and at least a portion of the first and second lateral cells is above the cushion layer.
wherein applying pressure on a first buttock cell causes fluid found within the first buttock cell upon which pressure was applied to flow into one or more of the first lateral cells, and wherein relief of pressure from a first buttock cell causes fluid found within one or more of the first lateral cells to flow into the first buttock cell from which pressure was relieved; and
wherein applying pressure on a second buttock cell causes fluid found within the second buttock cell upon which pressure was applied to flow into one or more of the second lateral cells, and wherein relief of pressure from a second buttock cell causes fluid found within one or more of the second lateral cells to flow into the second buttock cell from which pressure was relieved.

16. A method for inducing an individual to shift body weight from a first body surface to a second body surface comprising:
(a) providing a seat cushion according to claim 1; and
(b) seating the individual on the seat cushion.

17. The seat cushion according to claim 6, wherein one or more of the conduits is provided with a flow-meter.

18. The seat cushion according to claim 7, further comprising a processor configured to analyze the flow measurements to determine when a user of the cushion has shifted body-weight between different buttock cells.

19. The seat cushion according to claim 8, further comprising an alarm and the processor is configured to activate the alarm when the user has not shifted body-weight between different buttock cells in accordance with a predetermined pattern of body-weight shifting.

20. A system comprising a chair or a wheelchair and a seat cushion according to claim 15.
